(19) United States
(12) Patent Application Publication
(10) Pub. No.: US 2022/0195232 A1
(43) Pub. Date: Jun. 23, 2022

(54) EXPANDED LOW-DENSITY POLYETHYLENE INSULATION COMPOSITION

(71) Applicant: Dow Global Technologies LLC, Midland, MI (US)

(72) Inventors: Wenke Miao, Shanghai (CN); Chao He, Shanghai (CN); Xianmin Xu, Shanghai (CN); Mohamed Esseghir, Lawrenceville, NJ (US); Xiaoxiong Miao, Shanghai (CN)

(21) Appl. No.: 17/604,561

(22) PCT Filed: Jul. 1, 2019
(86) PCT No.: PCT/CN2019/094237

§ 371 Date: Oct. 18, 2021

(51) Int. Cl. C09D 123/06; B32B 1/00; B32B 27/32; B32B 27/08; H01B 3/44

(52) U.S. Cl. CPC C09D 123/06; B32B 1/00; B32B 27/32; B32B 27/08; B32B 2307/204; B32B 2307/202; B32B 2255/26; B32B 2255/10; B32B 2307/72; H01B 3/441

(57) ABSTRACT

A cable includes (a) a conductor; and (b) an expanded polymeric coating surrounding at least a portion of the conductor, the expanded polymeric coating including: (i) 70.0 wt. % to 99.8 wt. % low-density polyethylene homopolymer; and (ii) 0.2 wt. % to 5.0 wt. % of expanded polymeric microspheres having a D50 average diameter of from 25 μm to 40 μm, wherein the expanded polymeric coating has a density of 0.75 g/cc or less.

### BACKGROUND

### Field of the Invention

The present invention generally relates to low-density polyethylene insulation compositions, and more specifically, to conductive cables comprising an expanded low-density polyethylene insulation around a conductor.

### INTRODUCTION

Transmission speed of high frequency signals within cables is important. The transmission speed of high frequency signals through cables is affected by the dielectric constant of any insulation material present on a surface of a conductor of the cable. The velocity of signal through a cable is higher the lower the dielectric constant of the insulation on the conductor surface of the cable.

Conventional solid insulations typically include fluorinated ethylene/propylene blends and polytetrafluoroethylene and exhibit a dielectric constant of 2.10 or greater. Expanded insulation offers the possibility of achieving dielectric constants below 2.10, however voids in microstructures of the expanded insulation needs to be homogenously dispersed to achieve such dielectric constants. Expanded insulation is formed via physical foaming or chemical foaming and typically includes a high-density polyethylene (HDPE), a low-density polyethylene (LDPE), and a nucleating agent. Physical foaming relies on a blowing agent, such as a gas, and a nucleating agent to achieve sufficiently consistent foaming. Chemical foaming relies on the decomposition or reaction of an additive in the insulation to produce a gas that causes foaming.

Recently, expansive microspheres have been utilized in physical foaming processes. Often, the expansive microspheres alone do not foam the insulation sufficiently or provide an even foaming of the insulation. As a result, blowing agents are used in combination with the expansive microspheres to achieve desired foaming properties. WO2018049555 utilizes expansive microspheres, but only as a nucleating agent for physical foaming blowing agents. For example, WO2018049555 discloses using at most 1.6 wt. % expansive microspheres specifically as a nucleating agent in conjunction with a fluororesin. EP1275688B1 explains that heat-expansive microspheres alone cannot stabilize an expanded insulation and do not provide uniformly sized cells when expanded. EP1275688B1 further explains that at a concentration of less than 9 parts by weight, insufficient expansion of the expansive microspheres occurs. As a result, EP1275688B1 utilizes chemical foaming agents in addition to expansive microspheres to provide adequate foaming.

Accordingly, it would be surprising to provide a cable comprising an expanded insulation that can achieve a dielectric constant below 2.10 using expansive microspheres without additional chemical or physical blowing agents.

### SUMMARY OF THE INVENTION

The present invention offers a cable comprising an expanded insulation which exhibits a dielectric constant below 2.10 using expansive microspheres without additional chemical or physical blowing agents.

The present invention is a result of discovering that density and melt strength of a resin of an expanded insulation affects the expansion of expansive microspheres which in turn affects the dielectric constant of the resulting expanded insulation. Utilizing a resin for the expanded insulation that comprises greater than 70 wt. % low-density polyethylene (LDPE) based on the expanded insulation weight, the expansive microspheres are more evenly dispersed within the resin and exhibit a greater expansion as compared to expanded insulations where less than 70 wt. % of the expanded insulation is LDPE.

The present invention is particularly useful for wire and cable conductor insulation.

According to a first aspect of the present invention, a cable, comprises:
(a) a conductor; and
(b) an expanded polymeric coating surrounding at least a portion of the conductor, the expanded polymeric coating comprising:
   (i) 70.0 wt. % to 99.8 wt. % low-density polyethylene homopolymer; and
   (ii) 0.2 wt. % to 5 wt. % of expanded polymeric microspheres having a D50 average diameter of from 25 μm to 40 μm, wherein the expanded polymeric coating has a density of 0.75 g/cc or less.

According to a second aspect of the present invention, a masterbatch composition includes:
(a) 70.0 wt. % to 99.8 wt. % low-density polyethylene homopolymer;
(b) 0.5 wt. % to 30 wt. % expanded polymeric microspheres; and
(c) 0 wt. % to 25 wt. % linear low-density polyethylene, wherein the masterbatch composition is free of high-density polyethylene, rubbers, azodicarbonamide and fluororesin.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated. Subscript values in polymer formulae refer to mole average number of units per molecule for the designated component of the polymer.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut fur Normung; and ISO refers to International Organization for Standards.

As used herein, the term “free of” means that less than 0.001 weight percent (wt. %) of a specified constituent or reaction products of the constituent based on the weight of that stated as “free of” the constituent.

### Cable

The cable of the present disclosure includes a conductor with an expanded polymeric coating surrounding at least a portion of the conductor. The cable may comprise an inner jacket positioned between the conductor and the expanded polymeric coating. The inner jacket may comprise linear low-density polyethylene as described in greater detail below. Incorporation of an inner jacket comprising linear low-density polyethylene may be advantageous in increasing the mechanical durability of the cable. Further, an outer jacket may surround at least a portion of the expanded polymeric coating. The outer jacket may comprise high-density polyethylene as described in greater detail below. Incorporation of an outer jacket comprising high-density polyethylene may be advantageous in increasing the mechanical durability of the cable. The cable may include more than one conductor. The conductor may be a solid component extending the length of the cable. The conductor may have a circular cross-sectional shape. The conductor may be electrically coupled with one or more connectors at ends of the cable. The conductor may comprise one or more metals such as copper, silver, gold and platinum. In examples of the cable including more than one conductor, each conductor may have an expanded polymeric coating. Optionally, the cable may include one or more additional layers or jackets which comprise a polymeric material and/or a metal. The conductor is an electrical conductor configured to transmit one or more electrical signals. The cable may be particularly useful as a small form-factor pluggable data cable.

### Polymeric Coating

The expanded polymeric coating surrounds at least a portion of the conductor. The expanded polymeric coating may be in direct contact with the conductor. The expanded polymeric coating may be partially or fully separated from direct contact with the conductor by an inner jacket. The expanded polymeric coating may be free of voids in either a portion or substantially throughout the cable. The expanded polymeric coating comprises low-density polyethylene homopolymer (LDPE). LDPE has a density ranging from 0.915 grams per cubic centimeter (g/cc) to 0.925 g/cc. Polymer and polymeric coating densities provided herein are determined according to ASTM method D792. LDPE can have a polydispersity index (“PDI”) in the range of from 1.0 to 30.0, or in the range from 2.0 to 15.0, as determined by gel permeation chromatography. LDPE suitable for use in the expanded polymeric coating can have a melt index (I₂) from 0.1 g/10 min to 20 g/10 min. Melt indices provided herein are determined according to ASTM method D1238. Unless otherwise noted, melt indices are determined at 190° C. and 2.16 Kg. LDPE resins are known in the art, commercially available, and made by processes including, but not limited to, solution, gas or slurry phase and Ziegler-Natta, metallocene or constrained geometry catalyzed (CGC). One example of a commercially available LDPE resin includes AXELERON™ CX-1258 NT LDPE compound, available from The Dow Chemical Company.

The expanded polymeric coating comprises LDPE from 70 wt. % to 99.8 wt. % of the expanded polymeric coating. The expanded polymeric coating may comprise 70 wt. %

or greater, or 71 wt. % or greater, or 72 wt. % or greater, or 73 wt. % or greater, or 74 wt. % or greater, or 75 wt. % or greater, or 76 wt. % or greater, or 77 wt. % or greater, or 78 wt. % or greater, or 79 wt. % or greater, or 80 wt. % or greater, or 81 wt. % or greater, or 82 wt. % or greater, or 83 wt. % or greater, or 84 wt. % or greater, or 85 wt. % or greater, or 86 wt. % or greater, or 87 wt. % or greater, or 88 wt. % or greater, or 89 wt. % or greater, or 90 wt. % or greater, or 91 wt. % or greater, or 92 wt. % or greater, or 93 wt. % or greater, or 94 wt. % or greater, or 95 wt. % or greater, or 96 wt. % or greater, or 97 wt. % or greater, or 98 wt. % or greater, or 99 wt. % or greater, or 99.8 wt. % or greater, while at the same time, 99.8 wt. % or less, or 99 wt. % or less, or 98 wt. % or less, or 97 wt. % or less, or 96 wt. % or less, or 95 wt. % or less, or 94 wt. % or less, or 93 wt. % or less, or 92 wt. % or less, or 91 wt. % or less, or 90 wt. % or less, or 89 wt. % or less, or 88 wt. % or less, or 87 wt. % or less, or 86 wt. % or less, or 85 wt. % or less, or 84 wt. % or less, or 83 wt. % or less, or 82 wt. % or less, or 81 wt. % or less, or 80 wt. % or less, or 79 wt. % or less, or 78 wt. % or less, or 77 wt. % or less, or 76 wt. % or less, or 75 wt. % or less, or 74 wt. % or less, or 73 wt. % or less, or 72 wt. % or less, or 71 wt. % or less or less of the expanded polymeric coating.

The expanded polymeric coating may comprise linear low-density polyethylene homopolymer (LLDPE). LLDPEs suitable for use herein may have a density ranging from 0.918 g/cc to 0.935 g/cc. LLDPEs suitable for use herein may have a melt index I₂ of 0.1 g/10 min. to 20 g/10 min. LLDPEs suitable for use herein can have a weight-average molecular weight (“Mw”) (as measured by gel-permeation chromatography) of 100,000 to 130,000 g/mol. Furthermore, LLDPEs suitable for use herein can have a number-average molecular weight (“Mn”) of 5,000 to 8,000 g/mol. Thus, in various embodiments, the LLDPE can have a molecular weight distribution (Mw/Mn, or polydispersity index (“PDI”)) of 12.5 to 26. Methods for preparing LLDPEs are generally known in the art and may include using either Ziegler or Philips catalysts, and polymerization can be performed in solution or gas-phase reactors. An example of a suitable commercially available LLDPE includes AXELERON™ CS-7540 NT LLDPE compound available from The Dow Chemical Company.

The expanded polymeric coating comprises LLDPE from 0 wt. % to 25 wt. % of the expanded polymeric coating. The LLDPE may be 0 wt. % or greater, 1 wt. % or greater, 2 wt. % or greater, 3 wt. % or greater, 4 wt. % or greater, 5 wt. % or greater, or 6 wt. % or greater, or 7 wt. % or greater, or 8 wt. % or greater, or 9 wt. % or greater, or 10 wt. % or greater, or 11 wt. % or greater, or 12 wt. % or greater, or 13 wt. % or greater, or 14 wt. % or greater, or 15 wt. % or greater, or 16 wt. % or greater, or 17 wt. % or greater, or 18 wt. % or greater, or 19 wt. % or greater, or 20 wt. % or greater, or 21 wt. % or greater, or 22 wt. % or greater, or 23 wt. % or greater, or 24 wt. % or greater, or 25 wt. % or greater, while at the same time, 25 wt. % or less, or 24 wt. % or less, or 23 wt. % or less, or 22 wt. % or less, or 21 wt. % or less, or 20 wt. % or less, or 19 wt. % or less, or 18 wt. % or less, or 17 wt. % or less, or 16 wt. % or less, or 15 wt. % or less, or 14 wt. % or less, or 13 wt. % or less, or 12 wt. % or less, or 11 wt. % or less, or 10 wt. % or less, or 9 wt. % or less, or 8 wt. % or less, or 7 wt. % or less, or 6 wt. % or less, or 5 wt. % or less, or 4 wt. % or less, or 3 wt. % or less, or 2 wt. % or less, or 1 wt. % or less of the expanded polymeric coating.

The expanded polymeric coating may be free of one or any combination of more than one component selected from a group consisting of high-density polyethylene (HDPE), rubbers, azodicarbonamide, and fluororesins. As used herein, HDPE is an ethylene-based polymer having a density of from 0.94 g/cc to 0.98 g/cc. HDPE has a melt index I₂ from 0.1 g/10 min to 25 g/10 min. A nonlimiting example of HDPE includes AXELERON™ CX-6944 NT HDPE compound, available from The Dow Chemical Company. As used herein, the term fluororesin covers fluorine containing polymers. An exemplary fluororesin includes polytetrafluoroethylene. As used herein, the term “rubber” encompasses a polymer or copolymer of a diene monomer.

The expanded polymeric coating may comprise one or more antioxidants. Examples of antioxidants include, but are not limited to, hindered phenols such as tetrakis[methylene(3,5-di-tert-butyl-4-hydroxyhydro-cinnamate)]methane; bis[(beta-(3,5-ditert-butyl-4-hydroxybenzyl)-methylcarboxyethyl)]sulphide; 4,4′-thiobis(2-methyl-6-tert-butyl-phenol); 4,4′-thiobis(2-tert-butyl-5-methylphenol); 2,2′-thiobis(4-methyl-6-tert-butylphenol); and thiodiethylene bis(3,5-di-tert-butyl-4-hydroxy)hydrocinnamate; phosphites and phosphonites such as tris(2,4-di-tert-butylphenyl)phosphite and di-tert-butylphenyl-phosphonite; thio compounds such as dilaurylthiodipropionate, dimyristylthiodipropionate, and distearylthiodipropionate; various siloxanes; polymerized 2,2,4-trimethyl-1,2-dihydroquinoline; n,n′-bis(1,4-dimethylpentyl-p-phenylenediamine); alkylated diphenylamines; 4,4′-bis(alpha, alpha-dimethylbenzyl)diphenylamine; diphenyl-p-phenylenediamine, mixed di-aryl-p-phenylenediamines, and other hindered amine anti-degradants or stabilizers. Antioxidants can be used, for example, in amounts of 0.01 wt. % to 5 wt. %, or from 0.01 wt. % to 0.1 wt. %, or from 0.01 wt. % to 0.3 wt. %, based on the weight of the expanded polymeric coating.

### Expansive Microspheres

The expanded polymeric coating comprises expanded polymeric microspheres. The expanded microspheres are the result of expansive polymeric microspheres transitioning from unexpanded microspheres to expanded microspheres. As the expansive microspheres undergo transition, the polymeric coating transitions from an unexpanded polymeric coating to an expanded polymeric coating. Expansive polymeric microspheres expand from the unexpanded state to the expanded state when exposed to heat. Expansive microspheres are monocellular particles comprising a shell of thermoplastic polymer encapsulating a volatile fluid. When heated, the thermoplastic polymer of the shell softens and the volatile material expands causing the microsphere to increase in size. On cooling, the thermoplastic polymer in the shell hardens and retains its enlarged dimension and gaseous volatile fluid remaining inside the microsphere condenses resulting in a gas pressure less than 101.325 kPa in the microsphere.

The thermoplastic polymer shell may comprise methyl methacrylate, acrylonitrile, vinylidene chloride, o-chlorostyrene, p-tertiarybutyl styrene, vinyl acetate and/or copolymers thereof. The volatile fluid inside the shell may comprise an aliphatic hydrocarbon gas such as isobutene, pentane, or iso-octane. The expansive polymeric microspheres exhibit expansion from the unexpanded state to the expanded state at a temperature ranging from 80° C. or greater, or 90° C. or greater, or 100° C. or greater, or 110° C. or greater, or 120° C. or greater, or 130° C. or greater, or 140° C. or greater, or 150° C. or greater, or 160° C. or greater, or 170° C. or greater, or 180° C. or greater, or 190° C. or greater, or 200° C. or greater, or 210° C. or greater, or 220° C. or greater, or 230° C. or greater, or 240° C. or greater, while at the same time, 250° C. or less, or 240° C. or less, or 230° C. or less, or 220° C. or less, or 210° C. or less, or 200° C. or less, or 190° C. or less, or 180° C. or less, or 170° C. or less, or 160° C. or less, or 150° C. or less, or 140° C. or less, or 130° C. or less, or 120° C. or less, or 110° C. or less, or 100° C. or less, or 90° C. or less. The expansive microspheres exhibit a start temperature at which some of the expansive microspheres begin to transition from the unexpanded state to the expanded state. The expansive microspheres exhibit a maximum temperature at which 95% or greater of the expansive microspheres have transitioned from the unexpanded state to the expanded state. The start temperature for “low temperature microspheres” as used herein is from 130° C. to 145° C. The start temperature for “high temperature microspheres” as used herein is from 155° C. to 175° C. Expansive polymeric microspheres are commercially available, for example, from Nouryon under the trademark EXPANCEL™. The microspheres are typically spherical-shaped particles but may take a variety of shapes such as tubes, ellipsoids, cubes, particles and the like, all adapted to expand when exposed to thermal energy. The expansive microspheres have a D50 average diameter or longest linear dimension of from 25 μm to 40 μm or from 28 μm 38 μm as measured by laser light scattering on a Malvern Mastersizer Hydro 2000 SM apparatus on wet samples. The average diameter or longest linear dimension is presented as the D50 volume median diameter. For example, the average diameter or longest linear dimension of the expansive microspheres may be 25 μm or greater, or 26 μm or greater, or 27 μm or greater, or 28 μm or greater, or 29 μm or greater, or 30 μm or greater, or 31 μm or greater, or 32 μm or greater, or 33 μm or greater, or 34 μm or greater, or 35 μm or greater, or 36 μm or greater, or 37 μm or greater, or 38 μm or greater, or 39 μm or greater, while at the same time, 40 μm or less, or 39 μm or less, or 38 μm or less, or 37 μm or less, or 36 μm or less, or 35 μm or less, or 34 μm or less, or 33 μm or less, or 32 μm or less, or 31 μm or less, or 30 μm or less, or 29 μm or less, or 28 μm or less, or 27 μm or less, or 26 μm or less.

The expanded microspheres are from 0.2 wt. % to 5 wt. % of the expended polymeric coating. The expanded microspheres may be 0.2 wt. % of greater, or 0.5 wt. % or greater, or 1.0 wt. % or greater, or 1.5 wt. % or greater, or 2.0 wt. % or greater, or 2.5 wt. % or greater, or 3.0 wt. % or greater, or 3.5 wt. % or greater, or 4.0 wt. % or greater, or 4.5 wt. % or greater, or 5.0 wt. % or greater, while at the same time, 5.0 wt. % or less, or 4.5 wt. % or less, or 4.0 wt. % or less, or 3.5 wt. % or less, or 3.0 wt. % or less, or 2.5 wt. % or less, or 2.0 wt. % or less, or 1.5 wt. % or less, or 1.0 wt. % or less, or 0.5 wt. % or less of the expanded polymeric coating.

### Masterbatch

The polymeric coating of the present invention is formed using a masterbatch. As defined herein, the term “masterbatch” means a concentrated mixture of additives in a carrier resin. In the context of this invention, the masterbatch comprises expansive microspheres in a polyolefin resin comprising LDPE. The masterbatch of the present invention comprises LDPE from 70.0 wt. % to 99.8 wt. % and expansive microspheres from 0.5 wt. % to 30 wt. %. For example, masterbatch may comprise LDPE in a concentration of 70 wt. % or greater, or 71 wt. % or greater, or 72 wt. % or greater, or 73 wt. % or greater, or 74 wt. % or greater, or 75 wt. % or greater, or 76 wt. % or greater, or 77 wt. % or greater, or 78 wt. % or greater, or 79 wt. % or greater, or 80 wt. % or greater, or 81 wt. % or greater, or 82 wt. % or greater, or 83 wt. % or greater, or 84 wt. % or greater, or 85 wt. % or greater, or 86 wt. % or greater, or 87 wt. % or greater, or 88 wt. % or greater, or 89 wt. % or greater, or 90 wt. % or greater, or 91 wt. % or greater, or 92 wt. % or greater, or 93 wt. % or greater, or 94 wt. % or greater, or 95 wt. % or greater, or 96 wt. % or greater, or 97 wt. % or greater, or 98 wt. % or greater, or 99 wt. % or greater, or 99.8 wt. % or greater, while at the same time, 99.8 wt. % or less, or 99 wt. % or less, or 98 wt. % or less, or 97 wt. % or less, or 96 wt. % or less, or 95 wt. % or less, or 94 wt. % or less, or 93 wt. % or less, or 92 wt. % or less, or 91 wt. % or less, or 90 wt. % or less, or 89 wt. % or less, or 88 wt. % or less, or 87 wt. % or less, or 86 wt. % or less, or 85 wt. % or less, or 84 wt. % or less, or 83 wt. % or less, or 82 wt. % or less, or 81 wt. % or less, or 80 wt. % or less, or 79 wt. % or less, or 78 wt. % or less, or 77 wt. % or less, or 76 wt. % or less, or 75 wt. % or less, or 74 wt. % or less, or 73 wt. % or less, or 72 wt. % or less, or 71 wt. % or less of the weight of the masterbatch.

The masterbatch may comprise expansive microspheres from 0.5 wt. % to 30.0 wt. % weight of the masterbatch. For example, the masterbatch may comprise expansive microspheres in a concentration of 0.5 wt. % or greater, or 1 wt. % or greater, or 2 wt. % or greater, or 3 wt. % or greater, or 4 wt. % or greater, or 5 wt. % or greater, or 6 wt. % or greater, or 7 wt. % or greater, or 8 wt. % or greater, or 9 wt. % or greater, or 10 wt. % or greater, or 11 wt. % or greater, or 12 wt. % or greater, or 13 wt. % or greater, or 14 wt. % or greater, or 15 wt. % or greater, or 16 wt. % or greater, or 17 wt. % or greater, or 18 wt. % or greater, or 19 wt. % or greater, or 20 wt. % or greater, or 21 wt. % or greater, or 22 wt. % or greater, or 23 wt. % or greater, or 24 wt. % or greater, or 25 wt. % or greater, or 26 wt. % or greater, or 27 wt. % or greater, or 28 wt. % or greater, or 29 wt. % or greater, while the same time, 30 wt. % or less, or 29 wt. % or less, or 28 wt. % or less, or 27 wt. % or less, or 26 wt. % or less, or 25 wt. % or less, or 24 wt. % or less, or 23 wt. % or less, or 22 wt. % or less, or 21 wt. % or less, or 20 wt. % or less, or 19 wt. % or less, or 18 wt. % or less, or 17 wt. % or less, or 16 wt. % or less, or 15 wt. % or less, or 14 wt. % or less, or 13 wt. % or less, or 12 wt. % or less, or 11 wt. % or less, or 10 wt. % or less, or 9 wt. % or less, or 8 wt. % or less, or 7 wt. % or less, or 6 wt. % or less, or 5 wt. % or less, or 4 wt. % or less, o 3 wt. % or less, or 2 wt. % or less, or 1 wt. % or less weight of the masterbatch.

The masterbatch may comprise LLDPE from 0 wt. % to 25 wt. % weight of the masterbatch. For example, the masterbatch may comprise LLDPE in a concentration of 0 wt. % or greater, or 1 wt. % or greater, or 2 wt. % or greater, or 3 wt. % or greater, or 4 wt. % or greater, or 5 wt. % or greater, or 6 wt. % or greater, or 7 wt. % or greater, or 8 wt. % or greater, or 9 wt. % or greater, or 10 wt. % or greater, or 11 wt. % or greater, or 12 wt. % or greater, or 13 wt. % or greater, or 14 wt. % or greater, or 15 wt. % or greater, or 16 wt. % or greater, or 17 wt. % or greater, or 18 wt. % or greater, or 19 wt. % or greater, or 20 wt. % or greater, or 21 wt. % or greater, or 22 wt. % or greater, or 23 wt. % or greater, or 24 wt. % or greater, while the same time, 25 wt. % or less, or 24 wt. % or less, or 23 wt. % or less, or 22 wt. % or less, or 21 wt. % or less, or 20 wt. % or less, or 19 wt. % or less, or 18 wt. % or less, or 17 wt. % or less, or 16 wt. % or less, or 15 wt. % or less, or 14 wt. % or less, or 13 wt. % or less, or 12 wt. % or less, or 11 wt. % or less, or 10 wt. % or less, or 9 wt. % or less, or 8 wt. % or less, or 7 wt. % or less, or 6 wt. % or less, or 5 wt. % or less, or 4 wt. % or less, o 3 wt. % or less, or 2 wt. % or less, or 1 wt. % or less weight of the masterbatch.

The masterbatch may comprise LDPE from 97 wt. % to 99.5 wt. % and microspheres from 0.5 wt. % to 30.0 wt. %. The masterbatch may comprise LLDPE from 0 wt. % to 25 wt. % or may comprise LLDPE from 5 wt. % to 25 wt. %. The masterbatch may be free of HDPE, a rubber, azodicarbonamide, and/or a fluororesin.

### Cable Formation

The cable may be formed through the application of the masterbatch to the conductor before and/or after expansion of the expansive microspheres. In an exemplary implementation, the masterbatch is charged into an extruder comprising a screw and head. The masterbatch is charged into the extruder with additional LDPE resin. The masterbatch and LDPE resin are mixed and moved through the extruder by the screw while heated. One or more zones within the extruder, such as the head, heats the masterbatch and LDPE to a temperature above the start temperature of the expansive microspheres. The masterbatch and LDPE is then co-extruded with the conductor such that the masterbatch and LDPE surrounds the conductor as the polymeric coating. The expansive microspheres of the masterbatch, having been exposed to a temperature greater than the start temperature, may begin to transition from the unexpanded state to the expanded state both inside the extruder and after co-extrusion around the conductor. In examples where the cable includes the inner jacket and/or the outer jacket, the conductor may undergo previous or subsequent co-extrusions to the masterbatch and LDPE extrusion to form the inner jacket or outer jacket.

The expanded polymeric coating exhibits a dielectric constant of 2.10 as measured at 2.47 gigahertz (GHz) by ASTM method D1531. For example, the dielectric constant of the expanded polymeric coating may be 2.10 or less, or 2.00 or less, or 1.90 or less, or 1.80 or less, or 1.70 or less, or 1.60 or less, or 1.50 or less, while at the same time, 1.40 or greater, or 1.50 or greater, or 1.60 or greater, or 1.70 or greater, or 1.80 or greater, or 1.90 or greater, or 2.00 or greater.

The expanded polymeric coating exhibits a dissipation factor of 2.30 or less as measured at 2.47 GHz according to ASTM method D1531. The dissipation factor is a measure of loss-rate of energy of a mode of oscillation in a dissipative system. The dissipation factor may be 2.30 or less, or 2.20 or less, or 2.10 or less, or 2.00 or less, or 1.90 or less, or 1.80 or less, or 1.70 or less, while at the same time, 1.70 or greater, or 1.80 or greater, or 1.90 or greater, or 2.00 or greater, or 2.10 or greater, or 2.20 or greater, or 2.30 or greater.

The expanded polymeric coating has a density of 0.75 g/cc or less as measured according to ASTM method D792. For example, the expanded polymeric coating has a density of 0.75 g/cc or less, or 0.70 g/cc or less, or 0.65 g/cc or less, or 0.60 g/cc or less, or 0.55 g/cc or less, or 0.50 g/cc or less, or 0.45 g/cc or less, or 0.40 g/cc or less, or 0.35 g/cc or less, or 0.30 g/cc or less, while at the same time, 0.30 g/cc or more, or 0.35 g/cc or more, or 0.40 g/cc or more, or 0.45 g/cc or more, or 0.50 g/cc or more, or 0.55 g/cc or more, or 0.60 g/cc or more, or 0.65 g/cc or more, or 0.70 g/cc or more, or 0.75 g/cc or more.

The use of LDPE at 70 wt. % or greater of the expanded polymeric coating is advantageous for multiple reasons. First, the lower melt index of LDPE allows for greater expansion and homogenous distribution of the expansive microspheres in the expanded polymeric coating than polymeric coatings comprising HDPE. As the expansive microspheres have a greater degree of expansion and distribution within the expanded polymeric coating, the dielectric constant of the expanded polymeric coating is lower than for comparable expanded polymeric coatings which comprise HDPE. Second, the ability of LDPE to allow homogenous distribution and full expansion of the expansive microspheres allows for the elimination of azodicarbonamide from the expanded polymeric coating. As explained above, the decomposition of azodicarbonamide and other conventional nucleating agents may deleteriously affect the dielectric constant of expanded coatings. As the LDPE of the expanded polymeric coating allows for homogenous distribution and full expansion of the expansive microspheres, azodicarbonamide may be eliminated. The present invention also optionally permits the incorporation of LLDPE as a strengthening agent. The incorporation of LLDPE into the expanded polymeric coating allows for the increase in tensile strength and tensile elongation of the expanded polymeric coating. Optionally, the expanded polymeric coating of the cable may be free of fluororesins such as polytetrafluoroethylene (PTFE). Fluororesins as a solid insulation for cables may achieve a dielectric constant of 2.10 at 2.47 GHz, but are generally more expensive than LDPE. As such, the elimination of the fluororesins in addition to achieving a dielectric constant of 2.10 or less at 2.47 GHz is advantageous.

### EXAMPLES

Table 1 lists the constituents used to form Inventive Examples and Comparative Examples of Tables 2 and 3.

TABLE 1

| Constituent | Chemistry |
|---|---|
| LDPE | density: 0.922 g/cc; melt index I₂: 6.0 g/10 min (For example AXELERON ™ CX 1258 NT |
| | CPD LDPE compound from Dow Chemical) |
| LLDPE | density: 0.921 g/cc; melt index I₂: 0.7 g/10 min (For example LLDPE AXELERON ™ CS 7540 |
| | NT CPD LLDPE compound from Dow Chemical) |
| Low Temp. | diameter: 28 μm-38 μm; Start temp.: 133° C.-143° C.; Max. Temp.:190° C.-205° C. (For example |
| Microspheres | EXPANCEL ™ 951 DU 120 expansive microspheres from Nouryon) |
| High Temp. | diameter: 25 μm-40 μm; Start Temp.: 158° C.-173° C.; Max Temp.: 215° C.-235° C. (For example |
| Microspheres | EXPANCEL ™ 980 DU 120 expansive microspheres from Nouryon) |
| HDPE | density: 0.965 g/cc; melt index I₂: 8.0 g/10 min (for example Axeleron CX ™ 6944 NT CPD |
| | High-density polyethylene from Dow Chemical) |

### Sample Preparation

Prepare the Inventive Examples and the Comparative Examples by placing the resin components (e.g., the LDPE, LLDPE, HDPE) in an 815804 Brabender™ mixer at 120° C. Mix the components at a rotor speed of 10 revolutions per minute (RPM) until the resin constituents are melted. Charge the expansive microspheres into the mixer to form a mixture. Mix the expansive microspheres into the melted resin at 10 RPM for 2 minutes. Increase the mixing speed to 40 RPM and mix for 4 minutes at 120° C. Cool and cut the mixture.

Prepare solid plaques of the Inventive Examples and the Comparative Examples by placing 10 g pieces of the mixture within a 100 mm×100 mm×1 mm mold which is preheated at 120° C. for 10 minutes. Vent each sample 8 times by applying 1 megapascal (MPa) pressure and releasing the pressure. Press the sample in the mold at 10 MPa at 120° C. for 5 minutes. Cool the mold to 23° C. within 10 minutes while maintaining 10 MPa of force to form a solid plaque. Remove the solid plaque from the mold. Cut the solid plaques for testing samples.

Expand the solid plaques comprising expansive microspheres by placing each sample on a polyethylene terephthalate sheet with a 0.25 mm thickness in mold with the dimensions 195 mm×105 mm×2 mm. Heat the mold to 175° C. and allow expansion of the expansive microspheres for 10 minutes. Hot press the mold at 2 MPa of pressure for 2 minutes at 175° C. Increase pressure on the mold to 10 MPa while cooling the mold to 23° C. in 10 minutes. Cut the expanded plaques for testing samples.

Table 2 provides the composition of Comparative Examples (“CE”) A-F and Inventive Examples (“IE”) 1-4 as well as the associated mechanical and electrical properties. The wt. % values provided in Tables 2 and 3 are relative to the weight of the specific example they pertain to. Unless otherwise specified, the dielectric constant (“DC”) and dissipation factor (“DF”) of the Comparative and Inventive Examples was tested in accordance with

ASTM method D1531 and density tests were performed in accordance with ASTM method D792. The DC and DF measurements were performed on the examples prior to expansion while the example was in a solid state (“Solid DC” and “Solid DF”) and after the examples had been expanded (“Expanded DC” and “Expanded DF”). High temperature (“high temp.”) microspheres were utilized in examples comprising HDPE because the melting temperature of HDPE was above the start temperature of low temperature (“low temp.”) microspheres. The data for the Examples is provided for both solid, with the microspheres in the unexpanded state, and expanded, with the microspheres in the expanded state, states where available. The tensile strength and tensile elongation of the examples was measured in accordance with ASTM method D638. The tensile strength and tensile elongation measurements were performed on the examples prior to expansion while the example was in a solid state (“Solid Tensile Strength” and “Solid Tensile Elongation”) and after the expansive microspheres in the examples had been expanded (“Expanded Tensile Strength” and “Expanded Tensile Elongation”).

TABLE 2

| | Examples | | | | | | | | | |
|---|---|---|---|---|---|---|---|---|---|---|
| Constituent | CE-A | CE-B | IE-1 | IE-2 | IE-3 | IE-4 | CE-C | CE-D | CE-E | CE-F |
| LDPE (wt. %) | 100 | 99.8 | 99.5 | 99.0 | 98.0 | 97.0 | 5 | 10 | 4.5 | 9.0 |
| HDPE (wt. %) | — | — | — | — | — | — | 95 | 90 | 95 | 90 |
| Low Temp. | 0 | 0.2 | 0.5 | 1.0 | 2.0 | 3.0 | N/A | N/A | N/A | N/A |
| Microspheres | | | | | | | | | | |
| (wt. %) | | | | | | | | | | |
| High Temp. | N/A | N/A | N/A | N/A | N/A | N/A | N/A | N/A | 0.5 | 1.0 |
| Microspheres | | | | | | | | | | |
| (wt. %) | | | | | | | | | | |
| Total (wt. %) | 100 | 100 | 100 | 100 | 100 | 100 | 100 | 100 | 100 | 100 |
| Solid Density | 0.922 | 0.922 | 0.922 | 0.921 | 0.921 | 0.921 | 0.958 | 0.957 | 0.954 | 0.954 |
| (g/cc) | | | | | | | | | | |
| Expanded | N/A | 0.815 | 0.742 | 0.589 | 0.460 | 0.362 | N/A | N/A | 0.950 | 0.897 |
| Density (g/cc) | | | | | | | | | | |
| Solid DC | 2.27 | 2.28 | 2.29 | 2.29 | 2.29 | 2.29 | 2.34 | 2.34 | 2.33 | 2.34 |
| (2.47G Hz) | | | | | | | | | | |
| Expanded DC | N/A | 2.11 | 1.97 | 1.84 | 1.66 | 1.48 | N/A | N/A | 2.31 | 2.26 |
| (2.47G Hz) | | | | | | | | | | |
| Solid DF | 1.50E−4 | 1.70E−4 | 1.95E−4 | 2.15E−4 | 2.80E−4 | 3.75E−4 | 6.50E−5 | 7.50E−5 | 1.00E−4 | 1.30E−4 |
| (2.47G Hz) | | | | | | | | | | |
| Expanded DF | N/A | 1.70E−4 | 1.75E−4 | 1.90E−4 | 2.10E−4 | 2.30E−4 | N/A | N/A | 1.05E−4 | 1.45E−4 |
| (2.47G Hz) | | | | | | | | | | |
| Solid Tensile | 11 | 11.4 ± 0.6 | 10.3 ± 0.6 | 10.6 ± 0.2 | 10.2 ± 0.1 | 10.7 ± 0.2 | N/A | N/A | N/A | N/A |
| Strength | | | | | | | | | | |
| (MPa) | | | | | | | | | | |
| Expanded | N/A | 9.6 ± 0.2 | 10.0 ± 0.1 | 4.8 ± 0.2 | 3.8 ± 0.1 | 3.1 ± 0.1 | N/A | N/A | N/A | N/A |
| Tensile | | | | | | | | | | |
| Strength | | | | | | | | | | |
| (MPa) | | | | | | | | | | |
| Solid Tensile | 500 | 384.1 ± 80.8 | 359.9 ± 59.0 | 282.6 ± 99.4 | 183.7 ± 60.7 | 146.5 ± 27.6 | N/A | N/A | N/A | N/A |
| Elongation | | | | | | | | | | |
| (%) | | | | | | | | | | |
| Expanded | N/A | 66.1 ± 15.0 | 43.1 ± 5.1 | 35.1 ± 6.8 | 47.5 ± 4.7 | 47.5 ± 4.7 | N/A | N/A | N/A | N/A |
| Tensile | | | | | | | | | | |
| Elongation | | | | | | | | | | |
| (%) | | | | | | | | | | |

As can be seen in Table 2, the presence of expanded microspheres in Inventive Examples 1-4 lowers the dielectric constant of the Inventive Examples from 2.29 to less than 2.00. Comparative Example B exhibited a dielectric constant of 2.11, which is nearly at the target value of 2.10. Therefore, based on the trends in the other examples, it is safe to conclude that the incorporation of expansive microspheres at greater than 0.2 wt. % of the polymeric coating would exhibit dielectric constants of 2.10 or less. Comparative Examples E and F including expansive microspheres at 0.5 wt. % and 1.0 wt. % of the polymeric coating, respectively, exhibited dielectric constants of 2.31 and 2.26. The dielectric constants of Comparative Examples E and F are consistent with the understanding that the incorporation of HDPE into the polymeric coating both restricts the expansion of the expansive microspheres and decreases the homogeneity of the microsphere dispersion resulting in a higher dielectric constant. The dissipation factor of Inventive Examples 1-4 exhibited a decrease in the expanded plaques relative the solid plaques as compared to no change in the dissipation factor between the solid and expanded Comparative Examples.

Table 3 provides the composition of Comparative Examples G and H and Inventive Examples 1 and 5-8 as well as the associated mechanical and electrical properties. Table 3 differs from Table 2 in that Inventive Examples 5-8 incorporate LLDPE.

TABLE 3

| | Examples | | | | | | |
|---|---|---|---|---|---|---|---|
| Component | IE-1 | IE-5 | IE-6 | IE-7 | IE-8 | CE-G | CE-H |
| LDPE | 99.5 | 89.5 | 89.0 | 79.5 | 79.0 | 49.5 | 49.0 |
| LLDPE | 0 | 10.0 | 10.0 | 20.0 | 20.0 | 50.0 | 50.0 |
| Low Temp. | 0.5 | 0.5 | 1.0 | 0.5 | 1.0 | 0.5 | 1.0 |
| Micro spheres | | | | | | | |
| (wt. %) | | | | | | | |
| Total (%) | 100 | 100 | 100 | 100 | 100 | 100 | 100 |
| Solid Density | 0.922 | 0.921 | 0.921 | 0.920 | 0.920 | 0.920 | 0.919 |
| (g/cc) | | | | | | | |
| Expanded | 0.742 | 0.711 | 0.585 | 0.736 | 0.666 | 0.761 | 0.746 |
| Density (g/cc) | | | | | | | |
| Solid DC | 2.29 | 2.29 | 2.29 | 2.28 | 2.28 | 2.27 | 2.27 |
| (2.47G Hz) | | | | | | | |
| Expanded DC | 1.97 | 1.96 | 1.90 | 2.04 | 1.92 | 2.13 | 2.09 |
| (2.47G Hz) | | | | | | | |
| Solid DF (2.47G | 1.95E−4 | 1.85E−4 | 2.25E−4 | 2.00E−4 | 2.25E−4 | 2.15E−4 | 2.45E−4 |
| Hz) | | | | | | | |
| Expanded DF | 1.75E−4 | 1.70E−4 | 1.95E−4 | 1.80E−4 | 2.00E−4 | 2.00E−4 | 2.30E−4 |
| (2.47G Hz) | | | | | | | |
| Solid Tensile | 10.3 ± 0.6 | 11.7 ± 1.0 | 14.5 ± 0.2 | 14.5 ± 0.2 | N/A | 11.7 ± 1.0 | N/A |
| Strength (MPa) | | | | | | | |
| Expanded | 10.0 ± 0.1 | 7.1 ± 0.2 | 6.9 ± 0.2 | 6.9 ± 0.2 | N/A | 7.1 ± 0.2 | N/A |
| Tensile Strength | | | | | | | |
| (MPa) | | | | | | | |
| Solid Tensile | 359.9 ± 59 | 374.3 ± 105.3 | 542.0 ± 17 | 542.0 ± 17.7 | N/A | 374.3 ± 105 | N/A |
| Elongation (%) | | | | | | | |
| Expanded | 43.1 ± 5.1 | 65.8 ± 14.8 | 67.4 ± 12.3 | 67.4 ± 12.3 | N/A | 65.8 ± 14.8 | N/A |
| Tensile | | | | | | | |
| Elongation (%) | | | | | | | |

Based on conventional knowledge, it was unknown whether the incorporation of LLDPE would restrict the expansion of the polymeric microspheres sufficiently to minimize or eliminate the dielectric constant benefit provided by the expansive microspheres. Also unknown was the effect on mechanical properties of the addition of LLDPE into polymeric microstructures incorporating expansive microspheres. As discovered by the inventors of the present application and as can be seen in Table 3, the incorporation of LLDPE in Inventive Examples 5-8 did not impede the expanded polymeric coating from exhibiting dielectric constants below 2.10. As compared to Inventive Example 1, which has an expanded DC of 1.97 and no LLDPE, the Inventive Examples 5-8 all exhibit expanded dielectric constants of 2.10 or less. Inventive Examples 5-8 including LLDPE, in addition to exhibiting an expanded dielectric constant of less than 2.10, exhibited greater tensile strength and tensile elongation than examples without LLDPE such as Inventive Example 1. Accordingly, Inventive Examples 5-8 surprisingly exhibit both a dielectric constant below 2.10 and superior mechanical properties compared to examples which do not include LLDPE.

1. A cable, comprising:
(a) a conductor; and
(b) an expanded polymeric coating surrounding at least a portion of the conductor, the expanded polymeric coating comprising:
(i) 70.0 wt. % to 99.8 wt. % low-density polyethylene homopolymer; and
(ii) 0.2 wt. % to 5 wt. % of expanded polymeric microspheres having a D50 average diameter of from 25 um to 40 um, wherein the expanded polymeric coating has a density of 0.75 g/cc or less.

2. The cable of claim 1, wherein the expanded polymeric microspheres are present at a concentration from 0.5 wt. % to 3.0 wt. % weight of the expanded polymeric coating.

3. The cable of claim 1, wherein the density of the expanded polymeric coating is 0.6 g/cc or less.

4. The cable of claim 2, wherein the density of the expanded polymeric coating is 0.5 g/cc or less.

5. The cable of claim 1, wherein the low-density polyethylene homopolymer is present at a concentration of from 97.0 wt. % to 99.5 wt. % weight of the expanded polymeric coating and expanded polymeric microspheres are present at a concentration of from 0.5 wt. % to 3.0 wt. % weight of the expanded polymeric coating, further wherein the expanded polymeric coating has a density of 0.7 g/cc or less.

6. The cable of claim 1, wherein the expanded polymeric coating further comprises:
(iii) linear low-density polyethylene is present at a concentration of from 5.0 wt. % to 25.0 wt. % weight of the expanded polymeric coating.

7. The cable of claim 6, wherein the linear low-density polyethylene is from 10.0 wt. % to 20.0 wt. % weight of the expanded polymeric coating.

8. The cable of any claim 1, further comprising:
(c) an inner jacket comprising linear low-density polyethylene positioned between the conductor and the expanded polymeric coating; and
(d) an outer jacket surrounding the expanded polymeric coating comprising high-density polyethylene.

9. The cable of claim 1, wherein the expanded polymeric coating is free of high-density polyethylene, rubber and fluororesin.

10. A masterbatch composition, comprising:
(a) 70.0 wt. % to 99.8 wt. % low-density polyethylene homopolymer;
(b) 0.5 wt. % to 30.0 wt. % expanded polymeric microspheres; and
(c) 0 wt. % to 25.0 wt. % linear low-density polyethylene, wherein the masterbatch composition is free of high-density polyethylene, rubbers, azodicarbonamide and fluororesin.
